(19) United States
(12) Patent Application Publication
(10) Pub. No.: US 2006/0233365 A1
(43) Pub. Date: Oct. 19, 2006

(54) Random number generator

(75) Inventors: Katsuya Ohno, Kokubunji-shi (JP); Tomoyuki Fukuda, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/398,626

(22) Filed: Apr. 6, 2006

(30) Foreign Application Priority Data
Apr. 19, 2005 (JP) 2005-121457

(51) Int. Cl. H04L 9/00

(52) U.S. Cl. 380/46

(57) ABSTRACT

According to one embodiment, a clock generating unit configured to generate a clock having a predetermined frequency, an input value generating unit configured to generate an input value for predetermined encryption algorithm based on a generated clock, and a calculation processing unit configured to generate random number data by executing the encryption algorithm based on a generated input value are integrated, and a clock and an input value are enclosed inside the integrated circuit so as to be unobservable from the outside of the integrated circuit.

### CROSS-REFERENCE TO RELATED APPLICATIONS

This application is based upon and claims the benefit of priority from Japanese Patent Application No. 2005-121457, filed Apr. 19, 2005, the entire contents of which are incorporated herein by reference.

### BACKGROUND

1. Field

One embodiment of the present invention relates to an improvement in a random number generator which generates random number data for generating, for example, an encryption key.

2. Description of the Related Art

As is well known, there is disclosed one example of the above random number generator in Jpn. Pat. Appln. KOKAI Publication No. 2003-84668. This generator generates random number data using, as a seed and a key, a first pseudo random signal which is generated based on a first clock supplied from the outside and a second pseudo random signal which is generated based on a second clock obtained by randomly selecting a plurality of clocks having different frequencies supplied from the outside.

However, since the frequencies of the first and second clocks are previously known in the means for generating random number data described in Jpn. Pat. Appln. KOKAI Publication No. 2003-84668, the first and second pseudo random signals can be predicted, and therefore the random number data to be generated can be easily predicated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block structural diagram showing one embodiment of the present invention for explaining a schematic information processing system;

FIG. 2 is a block structural diagram for explaining a first example of a random number generating circuit used in the information processing system according to the embodiment;

FIG. 3 is a block structural diagram for explaining a second example of the random number generating circuit used in the information processing system according to the embodiment;

FIG. 4 is a block structural diagram for explaining a third example of the random number generating circuit used in the information processing system according to the embodiment; and

FIG. 5 is a block structural diagram for explaining a fourth example of the random number generating circuit used in the information processing system according to the embodiment.

### DETAILED DESCRIPTION

Various embodiments according to the invention will be described hereinafter with reference to the accompanying drawings. In general, according to one embodiment of the invention, a clock generating unit configured to generate a clock having a predetermined frequency, an input value generating unit configured to generate an input value for predetermined encryption algorithm based on a generated clock, and a calculation processing unit configured to generate random number data by executing the encryption algorithm based on a generated input value are integrated, and a clock and an input value are enclosed inside the integrated circuit so as to be unobservable from the outside of the integrated circuit.

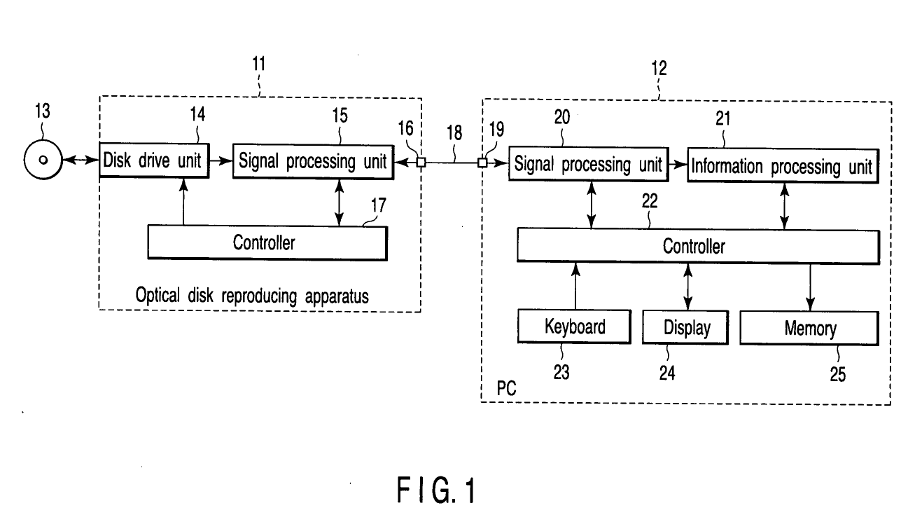

FIG. 1 shows a schematic information processing system explained according to this embodiment. This information processing system is assumed to be constituted such that an optical disk reproducing apparatus 11 is controlled by a personal computer (PC) 12.

In other words, the optical disk reproducing apparatus 11 comprises a disk drive unit 14 on which an optical disk 13 such as digital versatile disk (DVD) is mounted. This disk drive unit 14 reads out recording data from the mounted optical disk 13 and outputs it to a signal processing unit 15.

This signal processing unit 15 performs predetermined signal processing on input data for transmitting the same to the PC 12, and performs encryption processing on the signal-processed data to output from an input/output terminal 16 to the outside. A series of processing operations is collectively controlled by a controller 17 based on an instruction from the PC 12.

The data output from the input/output terminal 16 in the optical disk reproducing apparatus 11 is supplied to an input/output terminal 19 in the PC 12 via a cable 18. The data supplied to the input/output terminal 19 is decoded by a signal processing unit 20, and is then supplied to an information processing unit 21 for predetermined information processing.

A series of processing operations is collectively controlled by a controller 22. The controller 22 is connected with a keyboard 23, a display 24, a memory 25 and the like, and performs generation of instruction signals for the optical disk reproducing apparatus 11 or control of each unit such that a user's request is reflected.

In this case, an instruction signal for the optical disk reproducing apparatus 11 generated in the controller 22 is subjected to encryption processing by the signal processing unit 20, is supplied to the signal processing unit 15 in the optical disk reproducing apparatus 11 via the input/output terminal 19, the cable 18 and the input/output terminal 16, and is decoded in the signal processing unit 15 to be supplied to the controller 17.

Thereafter, the controller 17 in the optical disk reproducing apparatus 11 controls the disk drive unit 14 based on a decoded instruction signal so that the optical disk reproducing apparatus 11 is controlled by the PC 12. Also when the controller 22 in the PC 12 performs authentication with the controller 17 in the optical disk reproducing apparatus 11, encryption is performed for the data communication.

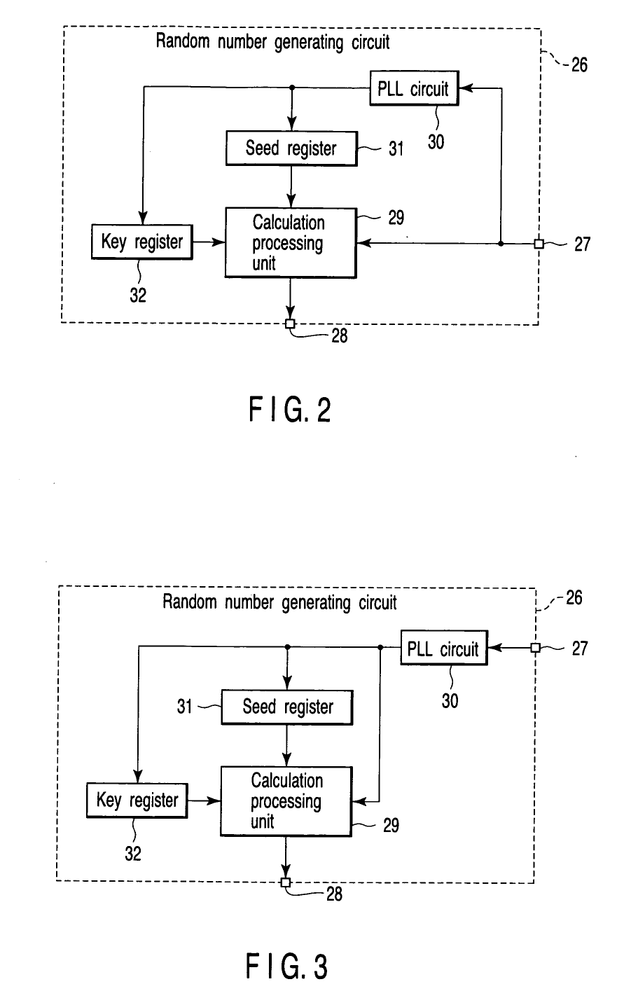

FIG. 2 shows a first example of a random number generating circuit 26 used for the encryption processing in the signal processing units 15, 20. In other words, the random number generating circuit 26 is integrated like, for example, large scale integration (LSI) and is provided with a clock input terminal 27 and a random number output terminal 28 for the outside.

When a reference clock having a predetermined frequency is supplied to the clock input terminal 27, the reference clock is given to a calculation processing unit 29 for executing encryption algorithm as an operation clock thereof.

The encryption algorithm to be executed by the calculation processing unit 29 employs well-known AES (advanced encryption standard), DES (data encryption standard), or hash algorithm such as SHA.

The reference clock supplied to the clock input terminal 27 is given to a phase locked loop (PLL) circuit 30 to be converted into a clock having a frequency different from the original one. Then, a clock to be output from the PLL circuit 30 is supplied to a seed register 31 and a key register 32, respectively.

The seed register 31 and the key register 32 generate a seed and a key to be given to the calculation processing unit 29 as input values for the encryption algorithm based on the input clocks, respectively, and for example, an M-series pseudo random number generator or counter which operates based on an input clock is used therefor.

Thus, the calculation processing unit 29 executes the encryption algorithm using the outputs of the seed register 31 and the key register 32 as the input values so that random number data is generated. The random number data generated in the calculation processing unit 29 is extracted to the outside via the random number output terminal 28 to be provided for the encryption processing.

According to the above first example, there is constituted such that the reference clock supplied to the clock input terminal 27 is converted into a clock having a frequency different from the original one by the PLL circuit 30. The seed register 31 and the key register 32 then generate a seed and a key to be given to the calculation processing unit 29 as the input values for the encryption algorithm based on the converted clock.

In other words, the clock to be supplied to the seed register 31 and the key register 32, and the seed and key generated based on the clock are enclosed inside the LSI constituting the random number generating circuit 26 so as to be unobservable from the outside of the LSI. Thus, the seed and key generated based on the clock is difficult to predict, and therefore the random number data to be generated from the calculation processing unit 29 can be made difficult to predict.

FIG. 3 shows a second example of the random number generating circuit 26. In FIG. 3, the same parts identical to those of FIG. 2 are denoted with the same reference numerals for description. The clock frequency-converted by a PLL circuit 30 is given to a calculation processing unit 29 as an operation clock thereof. Thus, the prediction of random number data to be generated from the calculation processing unit 29 can be made more difficult.

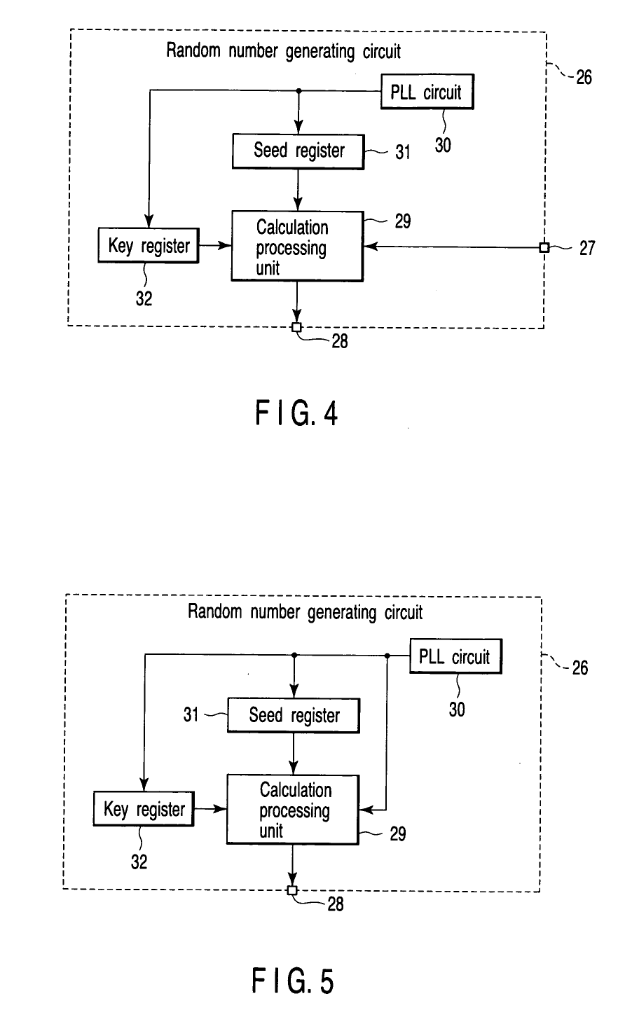

FIG. 4 shows a third example of the random number generating circuit 26. In FIG. 4, the same parts identical to those of FIG. 2 are denoted with the same reference numerals for description. A PLL circuit 30 uniquely generates a clock having a predetermined frequency to give it to a seed register 31 and a key register 32 without using a reference clock supplied to a clock input terminal 27.

FIG. 5 shows a fourth example of the random number generating circuit 26. In FIG. 5, the same parts identical to those of FIG. 2 are denoted with the same reference numerals for description. A PLL circuit 30 uniquely generates a clock having a predetermined frequency to give it to a calculation processing unit 29, a seed register 31 and a key register 32 without inputting a reference clock from the outside.

According to the first to fourth examples, in any one example, the clock generated in the PLL circuit 30 and the seed and key generated based on the clock are enclosed inside the LSI constituting the random number generating circuit 26 so as to be unobservable from the outside of the LSI.

Thus, the seed and key generated in the seed register 31 and the key register 32 are difficult to predict. Therefore, various input values for the encryption algorithm given to the calculation processing unit 29 are difficult to predict, which can make the prediction of random number data to be generated in the calculation processing unit 29 difficult.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A random number generator wherein a clock generating unit configured to generate a clock having a predetermined frequency, an input value generating unit configured to generate an input value for predetermined encryption algorithm based on a clock generated in the clock generating unit and a calculation processing unit configured to generate random number data by executing the encryption algorithm based on an input value generated in the input value generating unit are integrated, and
a clock generated in the clock generating unit and an input value generated in the input value generating unit are enclosed inside the integrated circuit so that observation is not possible from the outside of the integrated circuit.

2. A random number generator according to claim 1, further comprising an output terminal configured to derive random number data generated in the calculation processing unit to the outside of the integrated circuit.

3. A random number generator according to claim 1, wherein a clock generated in the clock generating unit is supplied to the calculation processing unit as an operation clock thereof.

4. A random number generator according to claim 1, further comprising an input terminal configured to input a reference clock into the integrated circuit from the outside,
wherein a reference clock input via the input terminal is supplied to the calculation processing unit as an operation clock thereof.

5. A random number generator according to claim 4, wherein the clock generating unit is configured to generate a clock having a frequency different from that of a reference clock based on the reference clock input via the input terminal.

6. A random number generator according to claim 1, wherein the input value generating unit is configured to use any one of an M-series pseudo random number generator and a counter operating based on an input clock.

7. A random number generator according to claim 1, wherein the input value generating unit is configured to generate a seed and a key as input values for the encryption algorithm.

8. An information processing apparatus comprising:
a random number generating unit configured such that a clock generating unit configured to generate a clock having a predetermined frequency, an input value generating unit configured to generate an input value for predetermined encryption algorithm based on a clock generated in the clock generating unit and a calculation processing unit configured to generate random number data by executing the encryption algorithm based on an input value generated in the input value generating unit are integrated, and a clock generated in the clock generating unit and an input value generated in the input value generating unit are enclosed inside the integrated circuit so as to be unobservable from the outside of the integrated circuit; and
a signal processing unit configured to perform encryption processing on data to be output to the outside based on random number data generated in the random number generating unit.

9. An information processing apparatus according to claim 8, further comprising an output terminal configured to derive random number data generated in the calculation processing unit to the outside of the integrated circuit.

10. An information processing apparatus according to claim 8, wherein a clock generated in the clock generating unit is supplied to the calculation processing unit as an operation clock thereof.

11. An information processing apparatus according to claim 8, further comprising an input terminal configured to input a reference clock into the integrated circuit from the outside,
wherein a reference clock input via the input terminal is supplied to the calculation processing unit as an operation clock thereof.

12. An information processing apparatus according to claim 11, wherein the clock generating unit is configured to generate a clock having a frequency different from that of a reference clock based on the reference clock input via the input terminal.

13. An information processing apparatus according to claim 8, wherein the input value generating unit is configured to use any one of an M-series pseudo random number generator and a counter operating based on an input clock.

14. An information processing apparatus according to claim 8, wherein the input value generating unit is configured to generate a seed and a key as input values for the encryption algorithm.
